(19) United States
(12) Patent Application Publication
(10) Pub. No.: US 2020/0045752 A1
(43) Pub. Date: Feb. 6, 2020

(54) Flight Simulator Electronic Flight Bag Link System

(71) Applicant: Jeffrey E Fouche, Coeur d Alene, ID (US)

(72) Inventor: Jeffrey E Fouche, Coeur d Alene, ID (US)

(21) Appl. No.: 16/052,013

(22) Filed: Aug. 1, 2018

(51) Int. Cl. H04W 76/10; G09B 9/08

(52) U.S. Cl. CPC H04W 76/10; H04W 84/12; G09B 9/08

(57) ABSTRACT

A software link that combines Internet weather, flight simulator position and velocity data, simulated aircraft traffic information and combines that data to a standard data stream delivered to an Electronic Flight Bag software app via intranet.

### BACKGROUND

An electronic flight bag (EFB) is an electronic information management device that helps flight crews perform flight management tasks more easily and efficiently with less paper. It replaces the traditional pilot's flight bag which carried paper documents to the cockpit for a pilot's use. Such flight bags were heavy and awkward in a small space. The electronic flight bag is a general purpose computing platform intended to reduce, or replace, the paper-based reference material which may have included the aircraft operating manual, the flight-crew operating manual, and navigational charts (including moving map for air and ground operations). The EFB can also host purpose-built software applications to automate other functions normally conducted by hand, such as performance take-off calculations. Unfortunately, technology has progressed faster than user training. It therefore would be desirable to have training for the use of the EFB in flight simulators and other electronic training platforms.

### SUMMARY OF INVENTION

An exemplary embodiment relates to a system for providing information. The system includes a flight simulator system, and an electronic flight bag (EFB) device. The system also includes a processing device, the processing device running a software link program. The software link program enables the connecting of the electronic flight bag device and the processing of data to enable the use of the electronic flight bag device with the flight simulator system and provide an NMEA information stream to the electronic flight bag device.

Another exemplary embodiment relates to a flight simulation system communicating with an electronic flight bag (EFB) for providing information to a user. The system includes a non-transitory computer readable medium having a software link program stored thereon. The software link program enables the connecting of the electronic flight bag device and the processing of data to enable the use of the electronic flight bag device with the flight simulator system and provide an NMEA information stream to the electronic flight bag device.

Yet another exemplary embodiment relates to a flight simulation system communicating with an electronic flight bag (EFB) for providing information to a user. The system includes a software link program module running on a processing device. The software link program module enables wireless connections to an electronic flight bag device. The software link program module has subprogram steps which enable the use of the electronic flight bag device with the flight simulator system, and a sub program module having subprogram steps to convert at least one of latitude/longitude, heading, and velocity to NMEA standards information and to provide the NMEA standards information to the electronic flight bag device.

### SUMMARY OF ILLUSTRATIONS

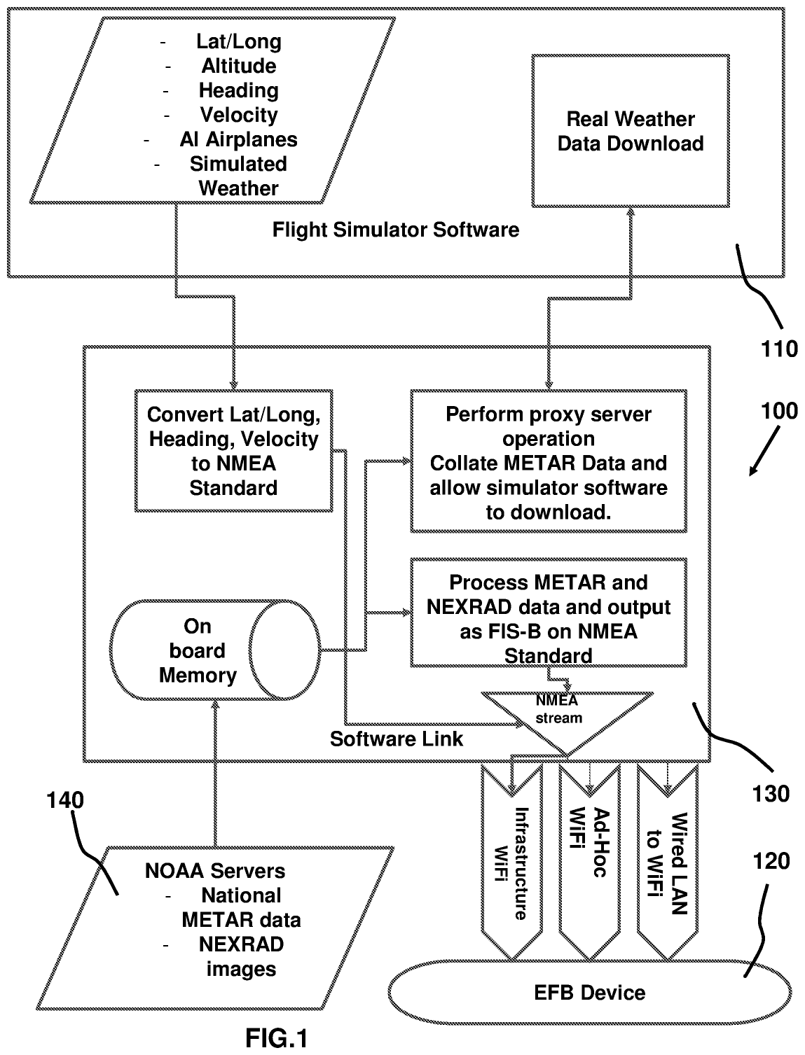

FIG. 1 shows the overall movement of data and data types to and from the Software Link and the Internet, simulator software, and EFB Device.

### DETAILED DESCRIPTION

As stated above, the rapid advance of technology has given rise to a multitude of software solutions called Electronic Flight Bags (EFB) for pilots that promise greater situational awareness, navigational usefulness, and readily available information in the cockpit. Along with this increase in capability has been an increase in the training and software knowledge for effective use of the products. While it is true that the end goal is proficient use of such software in the cockpit, many aspects of EFB use should be practiced in either a certified Aircraft Training Device or home-based PC flight simulator (collectively, flight simulators or simply simulators). Conventionally, the flight simulators available on the market either do not connect effectively to all (or any of) the capabilities of the EFB or present challenges or annoyances that preclude ready practice and proficiency with the EFB in conjunction with a flight simulator.

For the flight simulators that can connect to the EFB, the current state of the art does not make it simple and easy to deliver some of the more advanced data streams associated with the Federal Aviation Administration's (FAA) data products such as the Traffic Information and Flight Information Systems (TIS-B and FIS-B respectively, collectively ADS-B information) as part of the NEXTGEN Air Traffic Control System. The flight simulator may provide simulated position data based on whatever the aircraft might be doing in the simulator, but none of the other data that might normally be available to a pilot would be delivered. This presents a serious shortcoming; the corollary data that might be used in flight for decision making, situational awareness, traffic avoidance etc. is completely absent from where it might do the most good—the training environment. Also absent is an understanding of the capabilities and limitations of these systems in the simulated environment, forcing pilots to learn “on the job” while also performing the demanding duties of flying an airplane.

In accordance with an exemplary embodiment, a flight simulator system 100 is depicted in FIG. 1. System 100 includes Flight Simulator Software 110 running on any of a variety of computing devices including but not limited to personal computing devices, cloud based servers, dedicated simulator computers, and the like. Flight Simulator Software 110 provides the flight simulation environment for a user doing all of the modelling and calculations for providing simulation to one or more displays for a user.

In accordance with an exemplary embodiment, a Software Link 130 runs on any of a variety of computing devices including but not limited to the same computing device running the simulator software, an independent computing device (which may be a local or remote device), or EFB device 120. Software Link 130 provides all of the functionality which has made integration of EFB device 120 less than simple and less than satisfactory to Flight Simulation systems, thereby rendering flight simulation training lacking some elements of real world activity for the user.

Software Link 130 receives Flight Simulator 110 data, such as but not limited to Latitude/Longitude, Altitude, Heading, Velocity, Artificial Intelligence (AI) Airplane information, Simulated Weather information, Real World Weather Data, etc. In some embodiments, Software Link 130 receives Weather Information Source 140, such as but not limited to information from NOAA servers and METAR data. Software Link 130 also enables communication with EFB Device 120 through any of a variety of wireless or wired links. In a preferred embodiment the communication links are wireless links such as but not limited to WiFi, Bluetooth, Infrastructure WiFi, etc. The communication links may also include wired links such as but not limited to LAN or ethernet connections, etc.

In accordance with an exemplary embodiment, Software Link 130 manages the incoming information from Flight Simulator Software 110 and Weather Information Source 140. Software Link 130 includes functionality to Convert Latitude/Longitude, Heading, and velocity to NMEA Standards, etc. Software Link 110 receives data from Weather Information Source 140 to a Memory Location on board the computing device running Software Link 130. The Weather information, whether it be from Weather Information Source 140 or from the Real Weather Data Download of Flight Simulator Software 110, is used in a couple of steps including performance of proxy server operations, Collation of METAR data and allowing the simulator software to download. Software Link 130 also functions to process METAR data and NEXRAD data and output as FIS-B on NMEA Standard into the NMEA stream along with the converted Lat/Long, Heading, and Velocity. The NMEA stream is delivered to EFB device 120 for processing thereon.

It is thus desirable to use EFB device 120 to provide auxiliary information to a user of the flight simulation generated by Flight Simulation Software 110. EFB device 120 may be any of a variety of portable personal computing devices, such as but not limited to tablets, notebook computers, mobile phones, etc. which may be used by an individual utilizing the simulator software for additional auxiliary information, such as but not limited to weather information and map information, etc.

In accordance with an exemplary embodiment, Software Link 130 and associated hardware systems may be used to enable an easy, reliable, and useful link between a flight simulator and an EFB that also includes augmented data to simulate NEXTGEN data availability.

In accordance with an exemplary embodiment, users of Software Link 10 may be enabled to follow an easy initial setup that would accommodate reasonable configurations of their particular simulator and network. After the initial setup, Software Link 110 would automatically broadcast on the intranet, either WiFi or wired or both, as a standard ADS-B device commonly used in the EFB industry. This would allow any EFB running on any device to link to the software and receive the GPS and corollary data being used and generated by the simulator while connected to that same network.

Current software requires an IP (Internet Protocol) address of the destination EFB device connected to the same network. This conventionally requires the user to either force their device to use a fixed IP address OR enter in a new IP address each and every time they want to link their EFB to the simulator. In accordance with an exemplary embodiment Software Link 110 would act as the fixed IP receiver of the GPS data from the simulator. Once that setup is complete, many EFBs can automatically recognize the signal provided by the software link. This ability to rapidly, automatically, and easily connect the EFB to the Flight Simulator software represents a major improvement in ease of use for the simulator pilot.

Most current methods of connecting an EFB to a simulator can only support a single connection. Software Link 110 can support multiple connections, providing a big improvement in user experience as well as making it possible for a second pilot, such as a flight instructor, to participate in the simulation.

Software Link 110 can also receive simulated weather information from certain versions of existing software and convert it to a format that can be received by any EFB as FIS-B data. There is no current solution that provides this function.

When installed on capable hardware, Software Link 110 can form its own “ad-hoc” wireless network, allowing users to connect to that network and use the data services. This helps simulator pilots that would not otherwise have the ability to connect their EFB to their simulator due to lack of a WiFi network. It also allows bigger simulator flight schools to segregate data streams from multiple simulators, since each Software Link would be connected to a single simulator providing the data, then sending that data over its own WiFi connection to the pilot and crew.

Conventional methods to connect a simulator to an EFB device are specific only to one type of EFB device (such as an Apple iOS device), or the data can only be received on certain EFB devices with a 3rd party “app” that requires setup and activation each time the pilot wants to use their EFB with the simulator. Software Link 110 instead enables the broadcast of a standard NMEA data stream that all EFB apps running on all devices are designed to recognize and use.

Use of Software Link 110 acts as a go-between even on the largest, most sophisticated commercial simulators including but not limited to airline-level commercial simulators running any number of different software packages on the simulator end.

In accordance with an exemplary embodiment, Software Link 110 may be used to enable a commercial variant of the Beelynk to disable certain functions to add to the realism of a scenario in a simulator training session. For example, Software Link 110 may be used to disable any or all of: GPS signal from the simulator, FIS-B emulation to simulate a condition of being out-of-range of ground towers, TIS-B signal to simulate various scenarios. Further, Software Link 110 may enable disabling of aforementioned functions in various ways, such as “Instant”, “Upon reaching X altitude”, “Upon reaching X airspeed”, “Exact time until failure”, etc. This “failure” emulation functionality may be available on the “dashboard” mentioned below on commercial licenses of the Beelynk software.

Software Link 110 may be used with any of a variety of Flight Simulator variants including versions of Xplane, Lockheed Prepar3d, and other yet-to-be-determined simulator software environments (airline-level simulators).

Software Link 110 may also be used to enable sharing the Beelynk emulations over an ad-hoc WiFi network created by the Beelynk for use by EFB devices connected directly to the WiFi. Alternatively or additionally, Software Link 110 may be used to enable sharing the Beelynk emulations over an Ethernet connection that is then used as needed on infrastructure WiFi networks as desired by the user. Also, alternatively or additionally, Software Link 110 may be used to enable sharing an Internet connection over the ad-hoc WiFi network created by the Beelynk for use by EFB devices connected directly to said WiFi.

In accordance with an exemplary embodiment, Software Link 110 may enable the downloading of NOAA (National Oceanographic and Atmospheric Association) or similar METAR (weather observation) database information and parsing to within a specified distance of the current Lat/Long position of the simulator prior to broadcast on the FIS-B emulation to prevent data overload of the EFB, and ALSO passing this same METAR database to XPlane 9.7 by means of a proxy service to allow weather download. Further, Software Link 110 may enable receiving METAR and NEXRAD (color coded radar imagery) data from XPlane 10+ or other capable simulator software and converting to FIS-B data stream usable by all compatible EFB devices. Further still, Software Link 110 may enable receiving AI (Artificial Intelligence) aircraft traffic information from XPlane 10+ and converting to TIS-B data stream usable by all compatible EFB devices. Yet further still, Software Link 110 may enable receiving traffic output on fixed IP address from a PilotEdge plugin running on simulator and converting to TIS-B emulation for use by all compatible EFB devices. Software Link 110 may also enable receiving lat/long, speed, heading, and altitude information from the simulator and constructing AHRS (Automated Heading and Reference System) data for use in synthetic vision and artificial instrument panel functions in compatible EFBs.

In accordance with an exemplary embodiment Software Link 110 may also enable downloading NOAA (or similar) weather service NEXRAD regional imagery and converting to FIS-B NEXRAD product for distribution on a Beelynk emulation. This information may be parsed for Lat/Long distance to simulator position.

In accordance with an exemplary embodiment Software Link 110 may further enable the control of a Beelynk host device and various other utilities via a “dashboard” that is a web page hosted in the Beelynk software and that accommodates any one of or combination of the following features:
Any device that is connected to the Beelynk software that is running an Internet browser may control and interact the Beelynk dashboard. Controlling and setting up the Beelynk does not require the use of a specific app (although a specific app may alternatively be used) or 2nd piece of software.
Initial setup, including WiFi and Ethernet network configuration and connection validation.
Change and maintenance of Internet and Intranet connections.
Device and emulation status, including various metrics as may be descriptive of the various emulations. For example, a status of the FIS-B emulation might be the number of METAR blocks being emulated to EFBs that are connected.
On-page and linked tutorial instructions in multimedia format (video, text, pictures) on various configuration tasks for initial setup of the Beelynk and common simulator software packages and plugins for the user.
Control of emulation functions as noted above, including turning on and off all emulations in a single button (master on/off).

It should be noted that the embodiments described may not be limited to conventional EFB devices but may be any device that may use the emulation data streams.

What is claimed is:

1. A system for providing information, comprising:
a flight simulator system;
an electronic flight bag (EFB) device;
a processing device, the processing device running a software link program, the software link program enabling the connecting of the electronic flight bag device and the processing of data to enable the use of the electronic flight bag device with the flight simulator system and provide an NMEA information stream to the electronic flight bag device.

2. The system of claim 1, wherein the software link converts at least one of latitude/longitude, heading, velocity to NMEA standard.

3. The system of claim 1, wherein the software link enables a communication link to the electronic flight bag device.

4. The system of claim 1, wherein the software link enables a communication link to the electronic flight bag device and the communication link is a wireless link.

5. The system of claim 1, wherein the software link enables a communication link to the electronic flight bag device and the communication link is a wired link.

6. The system of claim 1, wherein the software link enables processing of weather data.

7. The system of claim 1, wherein the EFB device includes a tablet device.

8. A flight simulation system communicating with an electronic flight bag (EFB) for providing information to a user, comprising:
a non-transitory computer readable medium having a software link program stored thereon, the software link program enabling the connecting of the electronic flight bag device and the processing of data to enable the use of the electronic flight bag device with the flight simulator system and provide an NMEA information stream to the electronic flight bag device.

9. The system of claim 8, wherein the software link converts at least one of latitude/longitude, heading, velocity to NMEA standard.

10. The system of claim 8, wherein the software link enables a communication link to the electronic flight bag device.

11. The system of claim 8, wherein the software link enables a communication link to the electronic flight bag device and the communication link is a wireless link.

12. The system of claim 8, wherein the software link enables a communication link to the electronic flight bag device and the communication link is a wired link.

13. The system of claim 8, wherein the software link enables processing of weather data.

14. The system of claim 8, wherein the EFB device includes a tablet device.

15. A flight simulation system communicating with an electronic flight bag (EFB) for providing information to a user, comprising:
a software link program module running on a processing device, the software link program module enabling wireless connections to an electronic flight bag device, the software link program module having subprogram steps which enable the use of the electronic flight bag device with the flight simulator system, and a sub program module having subprogram steps to convert at least one of latitude/longitude, heading, and velocity to NMEA standards information and to provide the NMEA standards information to the electronic flight bag device.

16. The system of claim 15, wherein the software link enables processing of weather data.

17. The system of claim 15, wherein the software link enables processing of weather data, the weather data including NOAA data.

18. The system of claim 15, wherein the software link enables processing of weather data, the weather data including NEXRAD image data.

19. The system of claim 15, wherein the software link enables processing of weather data, the software link program converting the weather data to FIS-B data.

20. The system of claim 15, wherein the wireless connections include at least one of WiFi connections and Bluetooth connections.
